(19) United States
(12) Patent Application Publication
(10) Pub. No.: US 2018/0250782 A1
(43) Pub. Date: Sep. 6, 2018

(54) SPINDLE AND INTERIOR COOLING CIRCUIT MODULE

(71) Applicant: Precision Machinery Research & Development Center, Taichung (TW)

(72) Inventors: Chi-Cheng KUO, Taichung (TW); Gin-Go WU, Taichung (TW); Hsing-Chieh HUANG, Taichung (TW)

(21) Appl. No.: 15/449,719

(22) Filed: Mar. 3, 2017

(51) Int. Cl. B23Q 11/10; F25B 19/00

(52) U.S. Cl. CPC B23Q 11/1015; B23Q 11/1053; F25B 19/005

(57) ABSTRACT

A spindle and interior cooling circuit module for delivery cryogenic fluids. The spindle has an interior coaxially equipped with a mandrel and a drawbar. The drawbar has an interior coaxially equipped with a small diameter tube. An insulated layer coated between the interior wall of drawbar and the exterior wall of insulated layer. The insulated layer, made of thermal insulation material, lowers the thermal transmission effect between the small diameter tube and the drawbar of a spindle when the cryogenic fluids is delivering.

### BACKGROUND OF THE INVENTION

### 1. Field of the Invention

This invention relates an interior cooling circuit module for delivery cryogenic fluids through a spindle, particularly herein adapts materials of low thermal conductivity as an insulation coating on the passage between a drawbar and a small diameter tube for better insulation effect and lower maintenance costs.

### 2. Description of the Related Art

The spindle of a machine tool equipped with a mandrel withstood high-speed rotating driven by a motor. Said mandrel having a drawbar connecting a broaching mechanism at one end of spindle and a gripper mechanism subsequently at the opposite end of spindle. For uplifting cooling efficiency and lubricating purpose, the passage of the drawbar conveyed the cryogenic fluids, such as liquid nitrogen (LN₂), or liquid carbon dioxide (CO₂) spraying onto the working piece to increase the speed and quality of machining and the lifespan of cutting tool. In addition, said technique of cooling process with profound value could be applied to the aerospace industry in the process of difficult-to-cut material at the request of low thermal transmission conductivity.

However, when said cryogenic liquids was delivering through the passage, the spindle bearing would be damaged by the frost forming between the interior wall of mandrel and the exterior wall of drawbar. To solve said problem, U.S. Pat. No. 8,303,220 disclosed a cooling device for axial delivery of a cryogen coolant through a machine spindle. The coolant delivery tube 40 was surrounded by the outer sheath 43 and the inner small diameter tube 42, the space between said small diameter tube 42 and outer sheath 43 is vacuum to prevent said spindle bearing from the damage of thermal effect.

However, it needs improvement as the process of vacuum extraction would lead to the cost raising of assembling and manufacturing, and result in the difficulties of maintenance.

### SUMMARY OF THE INVENTION

In view of this, the present invention provides an interior cooling circuit module for delivery cryogenic fluids through a machine spindle. The spindle having a mandrel with an interior coaxially installed a drawbar. Said interior cooling circuit module includes a small diameter tube coaxially equipped in the interior of drawbar. A tangible insulated layer, made of thermal insulation material, is coated on the interior wall of drawbar and the exterior wall of small diameter tube for the insulation purpose of lowering the thermal transmission effect caused by the delivery of cryogenic fluids

Said thermal insulation material has the characteristics of low thermal transmission conductivity, such as heat-shrinkable joint tube, Polyvinyl chloride(PVC), Polytetrafluoroethylene(PTFE), Halogen-free flame retardant heat-shrinkable tube (RSFR), heat-shrinkable joint closure, Silica gel, Styrofoam, rubber . . . etc., or the chosen from porous or heat reflection materials such as foamed plastics, glass fiber cotton . . . etc. either one for alternation.

Said tangible insulated layer can be pre-coated on the exterior wall of small diameter tube or be filled up the passage between the exterior wall of small diameter tube and interior wall of drawbar.

### BRIEF DESCRIPTION OF THE DRAWINGS

FIG. 1 is a schematic view of embodiment to the drawbar and the interior cooling circuit module for delivery cryogenic fluids.

FIG. 2 is a schematic view of the embodiment.

FIG. 3 is a partial enlargement of the embodiment.

### DETAILED DESCRIPTION OF PREFERRED EMBODIMENTS

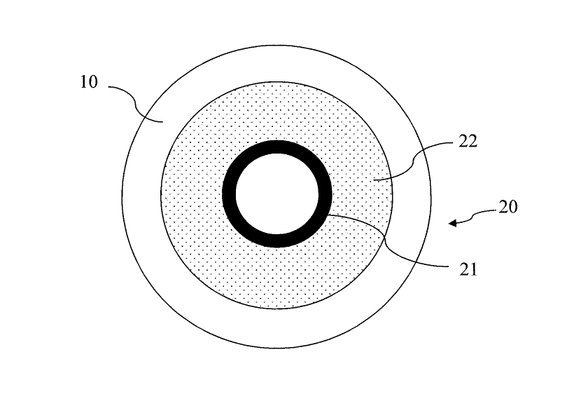

The below-mentioned specifying FIG. 1 the embodiment of present invention to the interior cooling circuit module for delivery cryogenic fluids. Said module 20 is installed in drawbar 10. Said drawbar is coaxially equipped in the interior of mandrel M of the machine spindle 1.

The interior cooling circuit module 20 is composed by small diameter tube 21 and the tangible insulated layer 22. In which the small diameter tube is coaxially installed in the drawbar 10. Therefore, the space between small diameter tube 21 and the drawbar 10 forms cylindrical. Said tangible insulated layer 22 fill up the cylindrical space between the exterior wall of small diameter tube 21 and the interior wall of drawbar 10.

The tangible insulated layer 22 made of thermal insulation material with the characteristic of lower transmission conductivity can be chosen from heat-shrinkable joint closure, Polyvinyl chloride(PVC), Polytetrafluoroethylene(PTFE), Halogen-free flame retardant heat-shrinkable tube(RSFR), Silica gel, Styrofoam, rubber . . . etc., or the other porous or heat reflection alternations such as foamed plastics, glass fiber cotton . . . etc.

Considering practical purpose for manufacturing, the tangible insulated layer 22 can be pre-coated on the exterior wall of small diameter tube before installing in the interior of drawbar 10. Furthermore, the way for insulation can change coating for filling. Therefore, the passage of interior of small diameter tube 21 delivers the cryogenic fluids, and the tangible insulated layer for better insulation lowers not only the thermal transmission effect between drawbar and small diameter tube, but also the damage possibility of spindle.

1. A spindle, comprises a mandrel, and a drawbar coaxially equipped in said mandrel, characterized in that said drawbar having an interior cooling circuit module for delivery cryogenic fluids; said interior cooling circuit module comprises a small diameter tube coaxially installing in said drawbar, a tangible insulated layer filled between an interior wall of said drawbar and an exterior wall of said small diameter tube; wherein the tangible insulated layer is pre-coated on the exterior wall of the small diameter tube.

2. The spindle of claim 1, wherein the material of said tangible insulated layer is selected from heat shrinkable joint closure, Polyvinyl chloride(PVC), Polytetrafluoroethylene(PTFE), Halogen-free flame retardant heat-shrinkable tube(RSFR), Silica gel, Styrofoam, or rubber.

3. (canceled)

4. (canceled)

5. The spindle of claim 1, wherein the tangible insulated layer is made of porous material or heat reflective material.

6. (canceled)

7. (canceled)

8. An interior cooling circuit module for delivery cryogenic fluids through a spindle comprises a drawbar inside of the spindle, a small diameter tube coaxially installed inside of the drawbar, and a tangible insulated layer filled between the interior wall of drawbar and the exterior wall of the small diameter tube; wherein the tangible insulated layer is pre-coated on the exterior wall of the small diameter tube.

9. The interior cooling circuit module of claim 8, wherein the material of said tangible insulated layer is selected from heat shrinkable joint closure, Polyvinyl chloride(PVC), Polytetrafluoroethylene(PTFE), Halogen-free flame retardant heat-shrinkable tube(RSFR), Silica gel, Styrofoam, or rubber.

10. (canceled)

11. (canceled)

12. The interior cooling circuit module of claim 8, wherein the tangible insulated layer is made of porous material or heat reflective material.

13. (canceled)

14. (canceled)
